(19) United States
(12) Patent Application Publication
(10) Pub. No.: US 2016/0114612 A1
(43) Pub. Date: Apr. 28, 2016

(54) NON-SLIP DESK CALENDAR

(71) Applicant: Woo-Seok JOUNG, Goyang-si, Gyeonggi-do (KR)

(72) Inventor: Woo-Seok JOUNG, Goyang-si (KR)

(21) Appl. No.: 14/894,920

(22) PCT Filed: May 23, 2014
(86) PCT No.: PCT/KR2014/004595

§ 371 Date: Nov. 30, 2015

(30) Foreign Application Priority Data
May 31, 2013 (KR) 10-2013-0062306

(51) Int. Cl. B42D 5/04

(52) U.S. Cl. CPC B42D 5/043

(57) ABSTRACT

The present invention relates to a desk calendar which is used by being put on a desk or a table and, particularly, to a non-slip desk calendar which will not slip on the desk or the table and can allow a user to take notes on the calendar in a very simple way. The non-slip desk calendar, according to the present invention, comprises: a first support plate and a second support plate formed such that cross sections thereof come in contact each other in a reversed-V shape such that the support plates can be folded; a spring binder coupled to holes punched in the folded portion between the first support plate and the second support plate; a calendar sheet coupled to the spring binder; a non-slip supporting element having “U”-shaped compressing plates formed to be separated from each other at a predetermined distance such that end portions of the first support plate and the second support plate are inserted into a coupling groove between the compressing plates; and a non-slip element formed on the lower end of the non-slip supporting element.

### TECHNICAL FIELD

The present invention relates to a desk calendar which may be used on a desk or a table, and in particular to a non-slip desk calendar wherein a user can easily make a note on a calendar since a calendar will not slip on a desk or a table.

### BACKGROUND ART

As illustrated in FIG. 1, for the sake of easier use on a desk or a table, a desk calendar in general is formed of a body wherein the ends of one side of each of a first support plate 10 and a second support plate 20 are connected through a spring 30, and the ends of the other side of each of the first support plate 10 and the second support plate 20 are connected through a connection plate 50, whereupon a lateral cross section of the body is formed in a triangle shape.

In the above conventional desk calendar, it is configured in such a way that before a user uses the desk calendar, the connection plate 50 is folded about a folding part 51, whereupon the first support plate 10 and the second support plate 20 remain closely contacted, namely, the desk calendar is distributed and stored in a flat shape. When the user uses it, as illustrated in FIG. 1, the connection plate 50 is unfolded, and the calendar is exploded into a triangle shape and is placed on a desk or a table for the use.

When the user wants to make a note on a calendar sheet 40, the user can make a note on the calendar sheet 40 in a state where the connection plate 50 is folded along a folding part 51. In this case, it may be very hard to make a note on the calendar sheet 40 due to the folded connection plate 50. The desk calendar may slip and fall off the desk or the table, which cause inconvenience.

Dust may gather on the connection plate 50, thus causing sanitary problem, and it needs to frequently wipe off the dust gathered on the connection plate 50.

In order to resolve the above mentioned problems, the Korean patent publication number 2008-51718 (Jun. 11, 2008) describes a support structure entitled “a support structure which is combined with a function of a cover sheet” wherein it is easy to make a note, and any slip can be prevented in such a way to engage a holder 70 to the ends of a front side 10 and a backside 20 of a calendar.

In the above support structure, since the front side 10 and the backside 20 are connected via a connection ring 40, there may be frequent problems since the above support structure may easily shake against external impact due to a gap present in the engaging structure, and it may fall due to any continuous shaking.

### DISCLOSURE OF THE INVENTION

### Technical Problem

Accordingly, the present invention is made in an effort to resolve the above problems. It is an object of the present invention to provide a non-slip desk calendar wherein a calendar is able to stably stand on a desk without any slip, and there are no shakes against any external impact, and it is easy to make a note.

### Solution to Problem

To achieve the above object, there is provided a non-slip desk calendar, which may include, but is not limited to, a first support plate and a second support plate which are formed foldable contacting with each other with their cross sections being formed in Λ-shapes; a spring binder which is engaged to holes formed on the folded portion between the first support plate and the second support plate; a calendar sheet which is engaged to the spring binder; a non-slip supporting element which is configured in such a way that a compressing plate is spaced apart at a predetermined interval in a U-shape, wherein the ends of the first support plate and the second support plate are inserted into an coupling groove formed between the compressing plates; and a non-slip element which is formed on a lower end of the non-slip supporting element.

At this time, in the non-slip supporting element, the U-shaped compressing plate is formed of a P.C. (Polycarbonate) material, and a non-slip element formed of a urethane TPE (thermoplastic elastomer) is formed by a double injection method on a lower end of the U-shaped compressing plate contacting with the surface of the desk.

In addition, in the non-slip supporting element, a head protrudes downward in such a way that a portion connecting to the compressing plate is formed in a semicircular shape, and the non-slip element is formed by the double injection method on the head.

In addition, a reinforcing unit protruding inward with a thickness is formed where the compressing plate is connected in the U-shape.

In addition, the compressing plate formed spaced apart from each other at a predetermined interval are formed inclined in such a way that the spaced-apart distances are gradually getting narrower in the direction of their ends.

In addition, the head is formed from an end of one side of the compressing plate and to an end of the other side, and both the ends of the head are spaced apart inward by a predetermined distance (w) from both the ends of the compressing plate.

To achieve the above object, there is provided a non-slip desk calendar, which may include, but is not limited to, a first support plate and a second support plate which are formed foldable contacting with each other with their cross sections being formed in A-shapes; a spring binder which is engaged to holes formed on the folded portion between the first support plate and the second support plate; and a calendar sheet which is engaged to the spring binder, wherein in the first support plate and the second support plate, an outer layer made of a non-slip material wraps an outer surface of a core, and the inner surfaces are finished with an inner layer.

At this time, the outer layer is formed of any of a wet P.U. (polyurethane) fabric, a fabric on a surface of which enamel is coated, and a R.P.-coated fabric.

### Advantageous Effects

In the non-slip desk calendar according to the present invention, it can stably stand on a desk without any slip and will not shake against any external impact, and a user can easily make a note on a calendar in such a way to fold the calendar like a book, thus providing convenience.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating a conventional non-slip desk calendar;

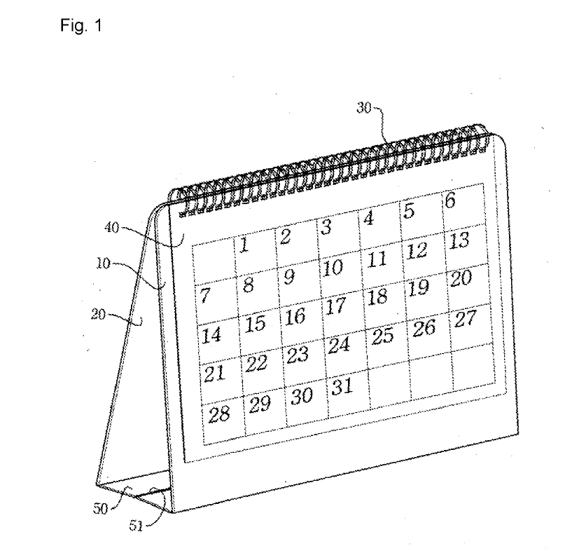

FIG. 2 is a perspective view illustrating a non-slip desk calendar according to an exemplary embodiment of the present invention;

FIG. 3 is a side view illustrating a non-slip desk calendar according to an exemplary embodiment of the present invention;

FIG. 4 is a perspective view illustrating a configuration wherein a non-slip support is engaged to a support plate of a calendar;

FIG. 5 is a cross sectional view illustrating a configuration wherein a non-slip support is engaged to a support plate of a calendar;

FIG. 6 is a partially enlarged perspective view illustrating a non-slip support before a double injection process;

FIG. 7 is a view illustrating a non-slip desk calendar according to another exemplary embodiment of the present invention; and

FIG. 8 is a use state view illustrating a state where a user makes a note by folding the calendar.

### MODES FOR CARRYING OUT THE INVENTION

The non-slip desk calendar according to the present invention will be described with reference to the accompanying drawings.

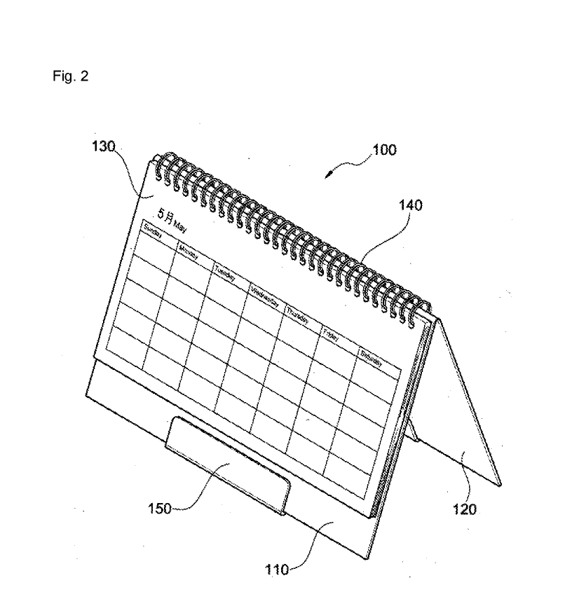

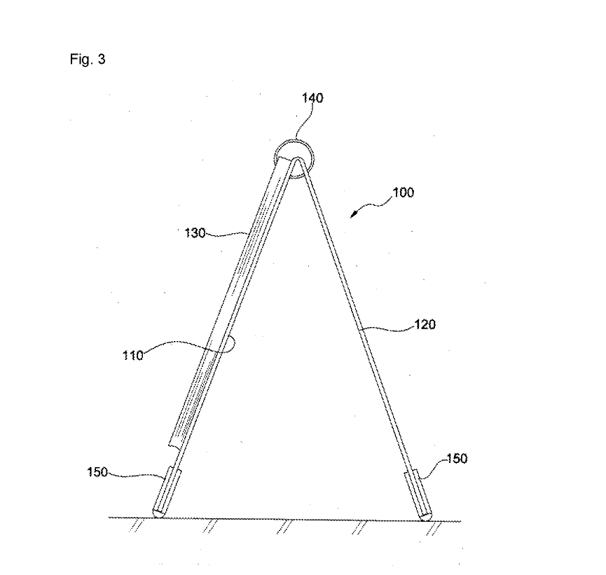

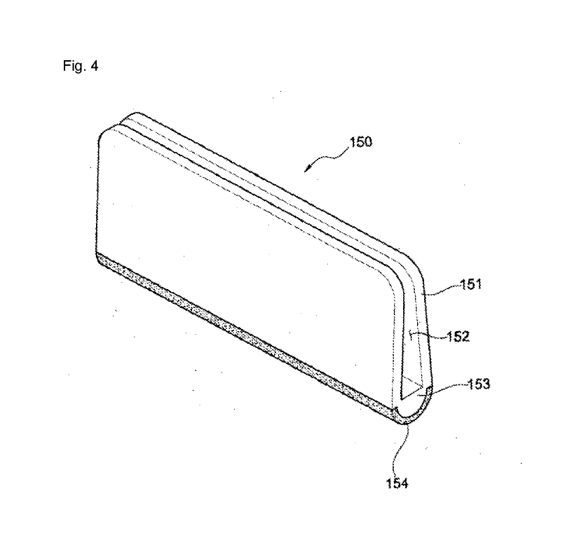

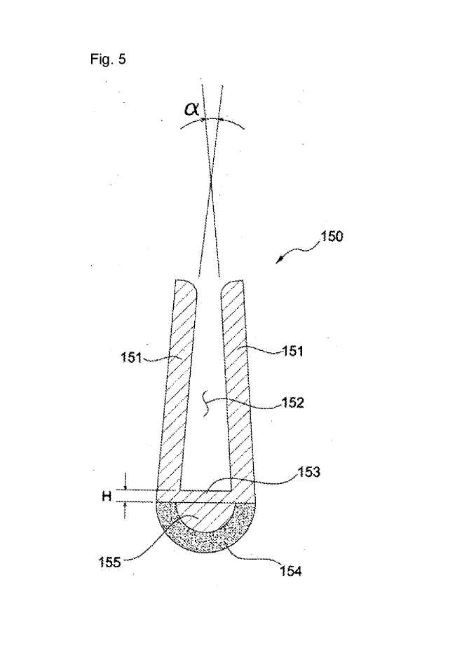

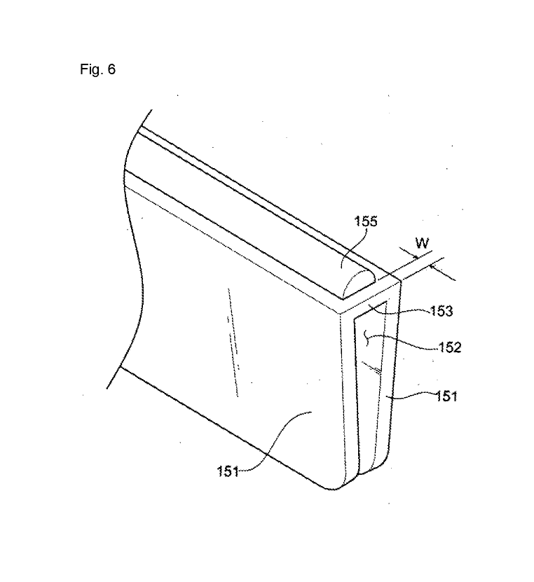

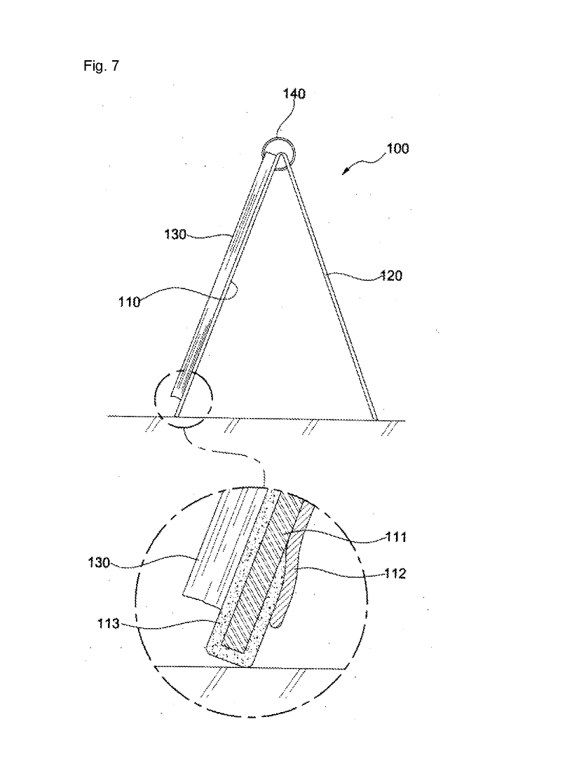

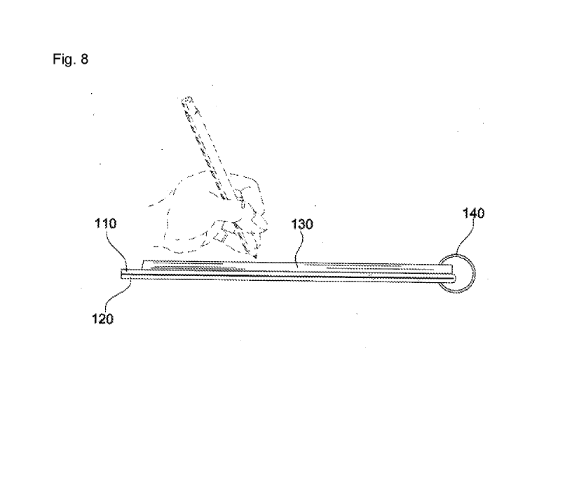

FIG. 2 is a perspective view illustrating a non-slip desk calendar according to an exemplary embodiment of the present invention, FIG. 3 is a side view illustrating a non-slip desk calendar according to an exemplary embodiment of the present invention, FIG. 4 is a perspective view illustrating a configuration wherein a non-slip support is engaged to a support plate of a calendar, FIG. 5 is a cross sectional view illustrating a configuration wherein a non-slip support is engaged to a support plate of a calendar, FIG. 6 is a partially enlarged perspective view illustrating a non-slip support before a double injection process, FIG. 7 is a view illustrating a non-slip desk calendar according to another exemplary embodiment of the present invention, and FIG. 8 is a use state view illustrating a state where a user makes a note by folding the calendar.

As illustrated in FIGS. 2 and 3, the non-slip desk calendar according to an exemplary embodiment of the present invention may include, but is not limited to, a first support plate 110 and a second support plate 120 which support a calendar 100; a calendar sheet 130; a spring binder 140 which engages the calendar sheet 130 to the support plates; and a non-slip supporting element 150 which is engaged to the first support plate 110 and the second support plate 120.

In the calendar according to the present invention, the first support plate 110 and the second support plate 120 form the body of the calendar. As illustrated in FIGS. 2 and 3, the first support plate 110 and the second support plate 120 are formed integral with each other in a A-shape so that they can fold against each other.

An engaging hole (reference number is not assigned) may be formed at a portion where the first support plate 110 and the second support plate 120 are folded, and as illustrated in FIGS. 2 and 3, the calendar sheets 130 are engaged to the engaging holes formed on the first support plate 110 or the second support plate 120 using the spring binder 140.

In the thusly constituted calendar 100, the first support plate 100 and the second support plate 120 are widened at a predetermined interval, thus fixing the calendar 100 on the desk. Since the first support plate 110 and the second support plate 120 are widened on the desk, the desk 100 may fall.

To this end, as illustrated in FIGS. 2 and 3, a non-slip supporting element 150 may be engaged to the ends of the first support plate 110 and the second support plate 120 so that the first support plate 110 and the second support plate 120 don't slip on the desk.

As illustrated in FIGS. 4 and 5, the non-slip supporting element 150 may include a compressing plate 151 at its both sides and may be formed in a U-shape. An coupling groove 152 into which the first support plate 110 or the second support plate 120 is inserted may be formed between the compressing plates 151. A non-slip element 154 may be formed on a lower end of the non-slip supporting element 150 so as to prevent any slip on the desk.

The non-slip supporting element 150 is formed of a P.C. (polycarbonate) material. The P.C. (polycarbonate) which is a material of the non-slip supporting element has good impact strength and dimensional stability. To this end, it is preferred that the non-slip supporting element 150 is formed of a P.C. material which is a reinforced plastic material lest the non-slip supporting element 150 will not transform after it is engaged with the support plates 110 and 120.

In addition, a non-slip element 154 is formed on a lower end of the non-slip supporting element 150 so as to prevent any slip. The non-slip element 154 may be manufactured by a double injection method using a TPE (Thermoplastic Elastomer) material.

The TPE which is the material of the non-slip element 154 has an elastomer characteristic at a room temperature. Thanks to the above elastomer characteristic, the non-slip element 154 can have a slip prevention function.

It is preferred that the non-slip element 154 is made of a urethane TPE material. Since the urethane TPE material is very heterozygous with the PC which is the material of the non-slip supporting element 150, the non-slip element 154 may be stably engaged to the non-slip supporting element 150 after a double injection, and a slip prevention performance is good.

As illustrated in FIG. 5, the U-shaped compressing plate 151 may be formed in such a way that the width of the compressing plate 151 is getting narrower in the direction of its end portion. More specifically, each compressing plate 151 may be formed with an inclined angle (a). For this reason, when the non-slip supporting element 150 fits into the first support plate 110 or the second support plate 120, the compressing plate 151 may strongly compress the support plate, so the non-slip supporting element 150 can be prevented from easily separating.

As illustrated in FIG. 5, the end of the compressing plate 151 is formed curved. In this way, it is preferred that the end of the compressing plate 151 is formed curved for the sake of easier insertion when the non-slip supporting element 150 is inserted into the support plate.

As illustrated in FIG. 5, a reinforcing unit 153 having a thickness of 0.3-0.6 mm is formed at a portion connecting the compressing plate 151 of the non-slip supporting element 150, namely, on the top of the head 155.

The non-slip supporting element 150 may be made by a double injection process. As mentioned above, due to the structure wherein the compressing plate 151 is getting narrower, there may be a problem where the non-slip supporting element 150 will not separate from the mold during the contraction work.

In the injection mold, if the injection is carried out in such a way that the compressing plate 151 of the non-slip supporting element 150 is formed parallel, the non-slip supporting element 150 may be easily separated from the mold.

If a reinforcing unit 153 having a thickness of 0.3-0.6 mm is formed on the top of the head 155 which connects the compressing plate 151, a high temperature non-slip supporting element 150 can slowly cool after the non-slip supporting element 150 has separated from the mold, and the compressing plate 151 is inclined by the contraction pressure of the reinforcing unit 53, whereupon it can be molded in a form where the opening is narrowed as illustrated in FIG. 5.

The reinforcing unit 153 is able to allow the non-slip supporting element 150 to smoothly separate from the mold during the injection, while guiding the compressing plate 151 to be inclined with each other after separations.

In addition, the reinforcing unit 153 may allow to support the compressing plate 151 so that the compressing plate 151 configured to compress the support plate is not transformed when the non-slip supporting element 150 is inserted into the support plate.

As illustrated in FIG. 6, the head 165 may be formed protruding on the top of the reinforcing unit 153 of the non-slip supporting element 150. The head 155 is where the non-slip element 154 is attached during the double injection work and may allow to increase a binding force by increasing the attachment area with the non-slip element 154 and save the material of the non-slip element 154 during the double injection work while allowing the compressing plate 151 to durably and closely contact with the support plate.

As illustrated in FIG. 6, the head 155 may be formed over both side ends of the non-slip supporting element 150. Both the side ends of the head 155 may be formed with a predetermined distance interval (w) of 0.1-0.5 mm from both the side ends of the non-slip supporting element 150.

If the head 155 is formed up to both the side ends of the non-slip supporting element 150, a non-slip element resin may protrude in a state where it is on both the side ends of the head 155 during the double injection of the non-slip element 154, so the exterior may look bad. For this reason, it is preferred that the head 155 may be formed with a predetermined distance being present from both the side ends of the non-slip supporting element 150 as illustrated in FIG. 6.

FIG. 7 is a side view illustrating a non-slip desk calendar according to another exemplary embodiment of the present invention.

In the another exemplary embodiment of the present invention, as illustrated in FIG. 7, the first support plate 110 and the second support plate 120 of the calendar 100 may play a role of the non-slip, whereupon the calendar 100 can be fixed on the desk.

In the another exemplary embodiment of the present invention, as illustrated in the partially enlarged drawing of FIG. 7, the first support plate 110 or the second support plate 120 may be finished with an inner layer 112 in a state where an outer layer 113 covers a core 111 in a wrapping type. The outer layer 113 contacting with the desk may be wrapped with the outer layer 113 made of the material of the non-slip material, thus implementing the another exemplary embodiment of the present invention.

The outer layer 113 may be made of a wet P.U. (Polyurethane) fabric, a fabric on the surface of which enamel is coated, or a R.P. coated fabric.

As illustrated in FIG. 7, the outer side surface of the core 111 is wrapped with the outer layer 113, and the inner surface of the core 111 is finished with the inner layer 112, whereupon the outer layer 113 of the support plate can stably and closely contact with the surface of the desk, whereby the calendar will not fall.

In the exemplary embodiment of the present invention as illustrated in FIG. 2, the calendar sheet 130 will not extend up to the lower end of the support plate in order to insert the non-slip supporting element 150 into the first support plate 110 and the second support plate 120, while leaving a space to insert therein the non-slip supporting element 150, whereas in the another exemplary embodiment of the present invention as illustrated in FIG. 7, the calendar sheet 130 may extend up to the lower end of the support plate, whereupon a neat and good-looking calendar 100 can be obtained.

In the thusly constituted present invention, the first support plat 110 and the second support plate 120 are formed integral with each other, whereupon the calendar 100 will not fall even when external impact applies to the calendar 100 which stands on the desk. Since there is not any gap between the first support plate 110 and the second support plate 120, there may be not any phenomenon where the calendar 100 which stands on the desk shakes due to gaps.

As illustrated in FIG. 8, in the calendar according to the present invention, if the first support plate 110 and the second support plate 120 are folded and laid on the desk, it may look flat like a notebook, which allows a user to make a note on the calendar sheet 130.

The non-slip desk calendar has been described so far according to the present invention.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A non-slip desk calendar, comprising:
a first support plate 110 and a second support plate 120 which are formed foldable contacting with each other with their cross sections being formed in A-shapes;
a spring binder 140 which is engaged to holes formed on the folded portion between the first support plate 110 and the second support plate 120;
a calendar sheet 130 which is engaged to the spring binder 140;
a non-slip supporting element 150 which is configured in such a way that a compressing plate 151 is spaced apart at a predetermined interval in a U-shape, wherein the ends of the first support plate 110 and the second support plate 120 are inserted into a coupling groove 152 formed between the compressing plates 151; and
a non-slip element 154 which is formed on a lower end of the non-slip supporting element 150.

2. The calendar of claim 1, wherein in the non-slip supporting element 150, the U-shaped compressing plate 151 is formed of a P.C. (Polycarbonate) material, and a non-slip element 154 formed of a urethane TPE (thermoplastic elastomer) is formed by a double injection method on a lower end of the U-shaped compressing plate 151 contacting with the surface of the desk.

3. The calendar of claim 2, wherein in the non-slip supporting element 150, a head 155 protrudes downward in such a way that a portion connecting to the compressing plate 151 is formed in a semicircular shape, and the non-slip element 154 is formed by the double injection method on the head 155.

4. The calendar of claim 1, wherein a reinforcing unit 153 protruding inward with a thickness (H) is formed where the compressing plate 151 is connected in the U-shape.

5. The calendar of claim 1, wherein the compressing plate 151 formed spaced apart from each other at a predetermined interval are formed inclined in such a way that the spaced-apart distances are gradually getting narrower in the direction of their ends.

6. The calendar of claim 3, wherein the head 155 is formed from an end of one side of the compressing plate 151 and to an end of the other side, and both the ends of the head 155 are spaced apart inward by a predetermined distance (w) from both the ends of the compressing plate 151.

7. A non-slip desk calendar, comprising:
a first support plate 110 and a second support plate 120 which are formed foldable contacting with each other with their cross sections being formed in A-shapes;
a spring binder 140 which is engaged to holes formed on the folded portion between the first support plate 110 and the second support plate 120; and
a calendar sheet 130 which is engaged to the spring binder 140,
wherein in the first support plate 110 and the second support plate 120, an outer layer 113 made of a non-slip material wraps an outer surface of a core 111, and the inner surfaces are finished with an inner layer 112.

8. The calendar of claim 7, wherein the outer layer 113 is formed of any of a wet P.U. (polyurethane) fabric, a fabric on a surface of which enamel is coated, and a R.P.-coated fabric.
